(19) United States
(12) Patent Application Publication
(10) Pub. No.: US 2026/0243566 A1
(43) Pub. Date: Aug. 20, 2026

(54) MEASUREMENT SYSTEM AND STORAGE MEDIUM STORING THEREON MEASUREMENT PROGRAM

(71) Applicant: KABUSHIKI KAISHA TOSHIBA, Kawasaki-shi (JP)

(72) Inventor: Hiroaki NAKAMURA, Kawasaki (JP)

(73) Assignee: KABUSHIKI KAISHA TOSHIBA, Kawasaki-shi (JP)

(21) Appl. No.: 19/411,893

(22) Filed: Dec. 8, 2025

(30) Foreign Application Priority Data
Feb. 19, 2025 (JP) 2025-025237

(51) Int. Cl. G01C 3/32; G01C 3/08; G06T 7/571

(52) U.S. Cl. CPC G01C 3/32; G01C 3/08; G06T 7/571; G06T 2207/10028

(57) ABSTRACT

A measurement system includes a processor. The processor calculates, from a measurement point cloud, a distance obtained by converting a shooting distance from a camera to a point of focus on a measurement target into a value in a space in which the measurement point cloud is arranged. The processor determines, using the distance as a constraint condition, one or more optimization parameters for an optimization process. The processor performs the optimization process using the determined one or more optimization parameters. The processor calculates one or more form deviations between a second point cloud and the measurement point cloud. The second point cloud is based on a first point cloud. The processor performs a visualized display on a display apparatus based on a result of the calculating of the one or more form deviations.

### CROSS-REFERENCE TO RELATED APPLICATION

This application is based upon and claims the benefit of priority from prior Japanese Patent Application No. 2025-025237, filed February 19, 2025, the entire contents of which are incorporated herein by reference.

### FIELD

Embodiments described herein relate generally to a measurement system and a storage medium storing thereon a measurement program.

### BACKGROUND

As a technique for supporting manufacture of large structures, a technique of overlaying a three-dimensional image of a component of a large structure in an ideal form over a three-dimensional image of the currently manufactured component generated based on three-dimensional measurement, thereby visualizing deviations of the form of the currently manufactured component from the ideal form, is known.

In such a visualization technique, it is requested that the measured point cloud and the ideal point cloud be aligned with high precision. A technique of automatically aligning the measured point cloud and the ideal point cloud is also known; however, if a measurement point cloud whose form can be easily compared with the ideal point cloud is not measured, the processing load for the alignment is expected to increase, resulting in an enormous amount of processing time. In addition, it is difficult for the user to measure a measurement point cloud whose form can be easily compared with an ideal point cloud. This is because, in order to measure a measurement point cloud whose form can be easily compared with an ideal point cloud, a high level of skill from a special technician is usually demanded.

In the present embodiment, a measurement system and a measurement program a storage medium storing thereon for aligning a measured point cloud and an ideal point cloud with high precision, without demanding a high level of skill for the measurement of the point cloud, is provided.

### BRIEF DESCRIPTION OF THE DRAWINGS

FIG. 1 is a block diagram showing a configuration of an example of a measurement system according to a first embodiment.

FIG. 2 is a diagram showing an example of a hardware configuration of the measurement system.

FIG. 3 is a flowchart showing a form deviation visualizing process as an operation of the measurement system according to the first embodiment.

FIG. 4 illustrates optimization parameters in a first example.

FIG. 5 illustrates optimization parameters in a second example.

FIG. 6 is a diagram showing generation of a simulation point cloud.

FIG. 7 is a block diagram showing a configuration of an example of a measurement system according to a second embodiment.

FIG. 8 is a flowchart showing a form deviation visualizing process as an operation of the measurement system according to the second embodiment.

FIG. 9A is a diagram showing an example of a point cloud generated by random sampling from ideal form data.

FIG. 9B is a diagram showing an example of a point cloud from which a hidden point cloud has been removed.

FIG. 10 is a block diagram showing a configuration of an example of a measurement system according to a third embodiment.

FIG. 11 is a flowchart showing a form deviation visualizing process as an operation of the measurement system according to the third embodiment.

### DETAILED DESCRIPTION

In general, according to one embodiment, a measurement system includes a processor. The processor calculates, from a measurement point cloud obtained by measuring a measurement target with a camera, a distance obtained by converting a shooting distance from the camera to a point of focus on the measurement target into a value in a space in which the measurement point cloud is arranged. The processor determines, using the distance as a constraint condition, one or more optimization parameters for an optimization process of aligning a position and a posture of a first point cloud and a position and a posture of the measurement point cloud, the first point cloud being generated from ideal form data representing an ideal form of the measurement target. The processor performs the optimization process using the determined one or more optimization parameters. The processor calculates one or more form deviations between a second point cloud and the measurement point cloud, the second point cloud being based on the first point cloud. The processor performs a visualized display on a display apparatus based on a result of the calculating of the one or more form deviations.

Hereinafter, embodiments will be described with reference to the accompanying drawings.

### First Embodiment

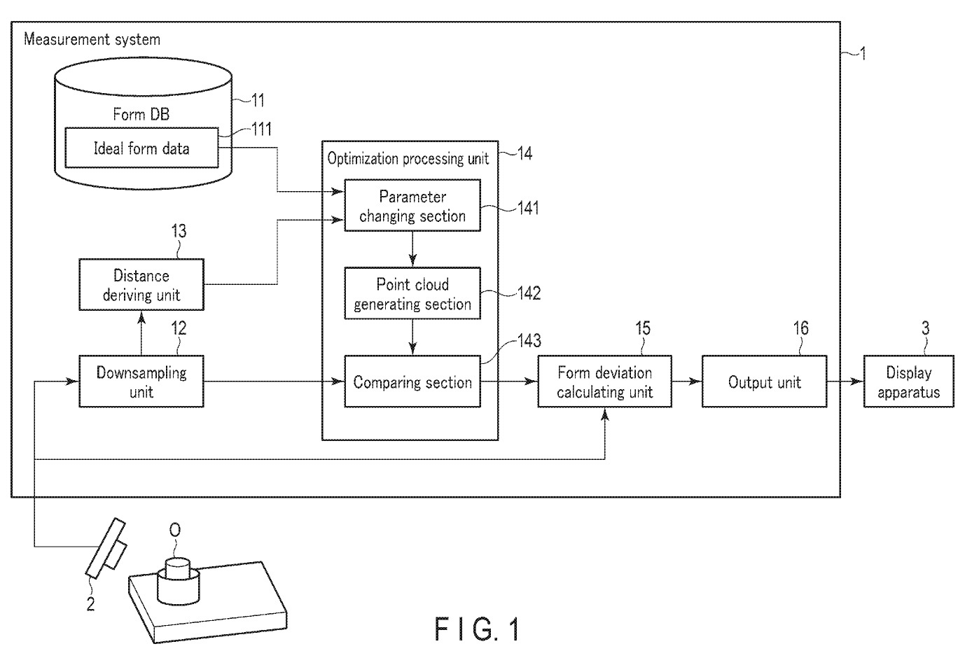

A first embodiment will be described. FIG. 1 is a block diagram showing a configuration of an example of a measurement system according to a first embodiment. The measurement system 1 may be used for measurement of a three-dimensional form of a measurement target.

The measurement system 1 according to the embodiment is adapted to compare a three-dimensional form of a measurement target O measured by a camera 2 with a three-dimensional form of an ideal measurement target, which is an ideal three-dimensional form of the measurement target O prepared in advance, and to present a form deviation therebetween to the user. The measurement target is, for example, a component to be welded into a large structure, but is not limited thereto. The number of types of measurement targets is not limited to one, and may be more than one.

As shown in FIG. 1, the measurement system 1 according to the first embodiment includes a form database (DB) 11, a downsampling unit 12, a distance deriving unit 13, an optimization processing unit 14, a form deviation calculating unit 15, and an output unit 16. The measurement system 1 is adapted to be able to communicate with a camera 2. The communication between the measurement system 1 and the camera 2 may be performed in either a wireless or wired manner. Also, the measurement system 1 is adapted to be able to communicate with a display apparatus 3. The communication between the measurement system 1 and the display apparatus 3 may be performed in either a wireless or wired manner.

The camera 2 is adapted to measure information related to a point cloud of the measurement target. The camera 2 is, for example, an RGB-D camera. An RGB-D camera is adapted to be able to measure an RGB-D image. An RGB-D image includes a depth image and an RGB color image. The depth image is a two-dimensional image having a depth of each point of the measurement target O as a value of the pixel. The color image is a two-dimensional image having RGB values of each point of the measurement target O as values of the pixel. A measurement point cloud representing a three-dimensional form of the measurement target O is obtained from the depth image. The measurement point cloud may be generated by the camera 2, or may be generated by the measurement system 1.

The display apparatus 3 is a liquid crystal display, an organic electroluminescent (EL) display, or the like. The display apparatus 3 is adapted to display various types of images based on data transferred from the measurement system 1.

The form DB 11 is a database adapted to store ideal form data 111 having an ideal three-dimensional form for each measurement target. The ideal form data may be, for example, three-dimensional (3D) computer-aided design (CAD) drawing data of the measurement target O. The form DB 11 may store at least one item of ideal form data for each measurement target.

Here, the form DB 11 may be provided on the exterior of the measurement system 1. In this case, the measurement system 1 acquires information from the form DB 11 as necessary.

The downsampling unit 12 is adapted to downsample the measurement point cloud to a density as low as that of a simulation point cloud to be generated by a point cloud generating section 142. The downsampling may be performed by a given technique, for example, by averaging adjacent point clouds. The downsampling may be omitted depending on, for example, the number of measurement point clouds.

The distance deriving unit 13 is adapted to derive a camera-to-measurement-point-cloud distance from the measurement point cloud. The camera-to-measurement-point-cloud distance is a distance obtained by converting a shooting distance from the camera 2 to a point of focus on the measurement target O into a value in a space in which the measurement point cloud is arranged. The point of focus may be, for example, a central position of the measurement point cloud. This is because, assuming that the measurement target O is shot with the camera 2, the central position of the measurement point cloud is highly likely to be at the point of focus, namely, the center of an angle of view. Here, the central position of the measurement point cloud may be derived by, for example, deriving an average of Z-direction coordinate values of a point cloud in the neighborhood of the center of a camera plane XY. The distance deriving unit 13 is adapted to install a virtual camera for the measurement point cloud based on a shooting distance and a shooting direction of the actual camera 2, and to derive, as the camera-to-measurement-point-cloud distance, a distance between the central position of the measurement point cloud and a position of the virtual camera.

The optimization processing unit 14 is adapted to acquire the ideal form data 111 from the form DB 11, and to optimize optimization parameters for an optimization process of aligning a position and posture of a simulation point cloud generated from the ideal form data 111 and those of the measurement point cloud. The optimization parameters include the position and posture of the simulation point cloud. In the present embodiment, the optimization processing unit 14 is adapted to imposture, based on the camera-to-measurement-point-cloud distance, constraints on information on the position and posture as the optimization parameters.

The optimization processing unit 14 includes a parameter changing section 141, a point cloud generating section 142, and a comparing section 143. The parameter changing section 141 is adapted to change at least one of the optimization parameters for the ideal form data 111 within the range of the constraints imposed based on the camera-to-measurement-point-cloud distance. The point cloud generating section 142 is adapted to generate a simulation point cloud from the ideal form data 111 in accordance with the changed optimization parameters. The simulation point cloud is an ideal point cloud representing an ideal form of the measurement target O, and is a point cloud used for calculating a form deviation. The simulation point cloud is obtained by generating, from the ideal form data 111, a point cloud to be acquired by a virtual camera arranged at the position and posture determined by the optimization parameters with reference to a point of focus on a 3D CAD model of the measurement target. The comparing section 143 is adapted to compare the simulation point cloud generated by the point cloud generating section 142 and a measurement point cloud downsampled by the downsampling unit 12 based on a similarity.

The form deviation calculating unit 15 is adapted to calculate form deviations between the simulation point cloud whose position and posture are optimized by the optimization processing unit 14 and a measurement point cloud not downsampled by the downsampling unit 12. The form deviation calculating unit 15 is adapted to calculate the form deviations from a discrepancies between corresponding points at an identical position on the simulation point cloud and the measurement point cloud, which have been aligned by the optimization processing unit 14. The form deviation may be, for example, a difference between values at an identical position on the simulation point cloud and the measurement point cloud.

The output unit 16 is adapted to perform a process for outputting a result of the form deviation calculation by the form deviation calculating unit 15. The output unit 16 is adapted, for example, to visualize the result of the form deviation calculation on the display apparatus 3. The visualization is performed by, for example, overlaying a three-dimensional image generated from simulation point clouds over a three-dimensional image generated from measurement point clouds and emphasizing portions at which form deviations between the measurement point clouds and the simulation point clouds are large. The emphasized display may be performed by a given method, for example, by changing the shading of the display colors according to the magnitude of the form deviation. The output unit 16 may be adapted to perform an outputting process other than the visualizing process, for example, causing a storage to store a result of the form deviation calculation.

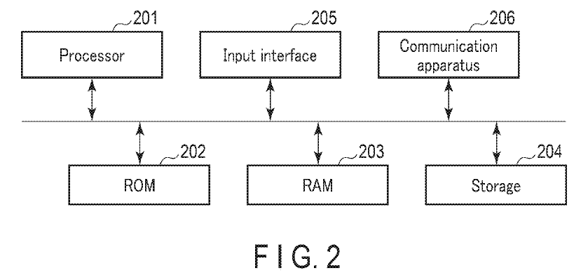

FIG. 2 is a diagram showing an example of a hardware configuration of the measurement system 1. The measurement system 1 may be a terminal apparatus of various types, such as a personal computer (PC), a tablet terminal, or the like. As shown in FIG. 2, the measurement system 1 includes, as hardware, a processor 201, a ROM 202, a RAM 203, a storage 204, an input interface 205, and a communication apparatus 206.

The processor 201 is adapted to control the overall operation of the measurement system 1. Through execution of, for example, a measurement program stored in the storage 204, the processor 201 operates as the downsampling unit 12, the distance deriving unit 13, the optimization processing unit 14, the form deviation calculating unit 15, and the output unit 16. The processor 201 is, for example, a central processing unit (CPU). The processor 201 may be a microprocessing unit (MPU), a graphics processing unit (GPU), an application-specific integrated circuit (ASIC), a field-programmable gate array (FPGA), or the like. The processor 201 may be either a single CPU, etc., or a plurality of CPUs, etc.

The read-only memory (ROM) 202 is a nonvolatile memory. The ROM 202 is adapted to store an activation program, etc., of the measurement system 1. The random-access memory (RAM) 203 is a volatile memory. The RAM 203 is used as a work memory in the course of processing by, for example, the processor 201.

The storage 204 is a storage such as a hard disk drive, a solid-state drive, or the like. The storage 204 is adapted to store various programs to be executed by the processor 201, such as the measurement program. Also, the storage 204 may be adapted to store the form DB 11. The form DB 11 is not required to be stored in the storage 204.

The input interface 205 includes an input apparatus such as a touch panel, a keyboard, a mouse, etc. If an operation is made on the input apparatus of the input interface 205, a signal corresponding to the operation is input to the processor 201. The processor 201 is adapted to perform various processes in response to the signal.

The communication apparatus 206 is adapted to allow the measurement system 1 to communicate with external equipment such as the camera 2 and the display apparatus 3. The communication apparatus 206 may be adapted for either wired or wireless communications.

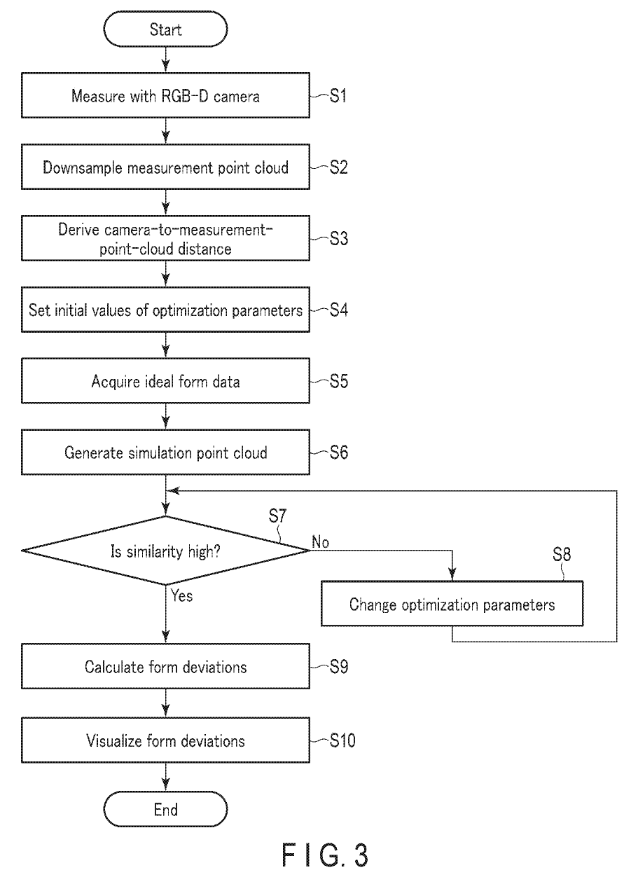

Next, an operation of the measurement system 1 according to the first embodiment will be described. FIG. 3 is a flowchart showing a form deviation visualizing process as the operation of the measurement system 1 according to the first embodiment. The processing of FIG. 3 is executed by the processor 201.

At step S1, the processor 201 controls the camera 2 to carry out measurement of a measurement target O. Thereby, the processor 201 acquires an RGB-D image from the camera 2. Here, the measurement of the measurement target O may be performed under the control of a system different from the measurement system 1. Alternatively, the measurement of the measurement target O may be performed by a user. In this case, the user carries out the measurement of the measurement target O by holding the camera 2 in his or her hand.

At step S2, the processor 201 generates a measurement point cloud from a depth image obtained from the camera 2, and downsamples the measurement point cloud to a density as low as that of a simulation point cloud. The downsampling may be performed by a given technique, for example, by averaging adjacent point clouds. Also, the measurement point cloud may be generated by the camera 2.

At step S3, the processor 201 derives, from the measurement point cloud, a camera-to-measurement-point-cloud distance. As described above, the camera-to-measurement-point-cloud distance may be derived as, for example, a distance between a central position of the measurement point cloud, which is derived as an average of Z-direction coordinate values of a point cloud in the neighborhood of the center of a camera plane XY, and a position of a virtual camera that is installed relative to the measurement point cloud.

At step S4, the processor 201 initializes optimization parameters. Hereinafter, the optimization parameters will be described.

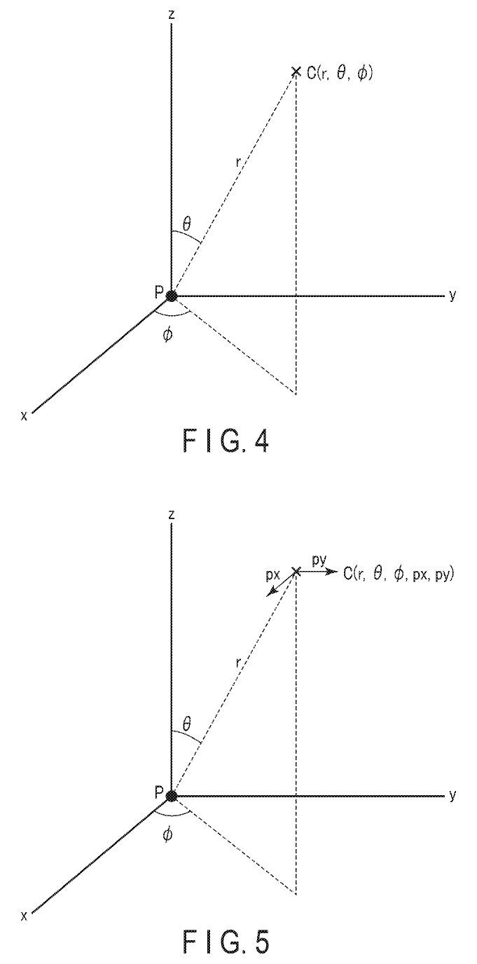

FIG. 4 illustrates the optimization parameters according to a first example. A situation where a measurement target O is measured by a camera 2, for example a case where the user moves the camera 2 to perform the measurement, is assumed. If, for example, the measurement target O is a component to be welded into a large structure, it can be expected that the user moves the camera 2 in such a manner that a welded position of the component in the large structure is captured with a suitable orientation at the center of an angle of view of the camera 2. In this case, a point of focus is the welded position. Also, the user may adjust the camera 2 so that the welded position is captured in a suitable orientation by rotating the camera 2 in a pitch direction or a yaw direction, with the point of focus fixed at the center of the angle of view of the camera 2. In such a motion, the distance between the point of focus and the camera becomes substantially constant. If such a motion of the camera 2 is considered to be a motion of a virtual camera C in a space in which a measurement point cloud is arranged, the motion of the camera C may be represented in a polar coordinate system in which a camera-to-measurement-point-cloud distance r is fixed, with a point of focus P as the origin, as shown in FIG. 4. Essentially, the camera 2 has six degrees of freedom for the position and posture, namely, three degrees of freedom for the position and three degrees of freedom for the posture, and thus the number of optimization parameters for optimizing the position and posture is six. On the other hand, in consideration of the situation where the point of focus is shot, the position and posture of the virtual camera C are determined by three: a camera-to-measurement-point-cloud distance r; a pitch angle θ; and a yaw angle φ. By regarding “r” to be constant, the number of optimization parameters can be reduced to two (the pitch angle θ and the yaw angle φ).

FIG. 5 illustrates optimization parameters according to a second example. In a situation where the measurement target O is actually measured with the camera 2, there may be a case where the camera 2 is translated in the x-axis or y-axis direction, which is a plane direction parallel to the ground surface, without substantially varying the distance between a point of focus and the camera 2. In this case, a position and posture of the virtual camera C are determined by five parameters: a camera-to-measurement-point-cloud distance r, a pitch angle θ, a yaw angle φ, and parallel translation amounts in directions parallel to a virtual ground surface in a space in which the camera C is arranged, namely, a parallel translation amount px in the x-axis direction and a parallel translation amount py in the y-axis direction. By regarding “r” to be constant, similarly to the example of FIG. 4, the number of optimization parameters can be reduced to four (the pitch angle θ, the yaw angle φ, the parallel translation amount px, and the parallel displacement amount py).

The larger the number of the optimization parameters is, the longer the calculation time will be, but the precision of the optimization process of the position and posture of the simulation point cloud is improved. Conversely, the smaller the number of the optimization parameters is, the shorter the calculation time will be, but the precision of the optimization process of the position and posture of the simulation point cloud is reduced. It is thus desirable, in the case where the calculation speed is given importance, that the optimization process be performed with the two optimization parameters shown in FIG. 4, and in the case where the precision of the optimization process is given importance, that the optimization process be performed with the four optimization parameters shown in FIG. 5. Whether the calculation speed is given importance or the precision of the optimization process is given importance may be fixedly determined, or may be determined according to the user’s selection, etc.

Here, reference is made back to FIG. 3. At step S4, after determining that the number of the optimization parameters is two or four, the processor 201 initializes each of the optimization parameters. The initial values of the pitch angle θ, the yaw angle φ, the parallel translation amount px, and the parallel translation amount py as the optimization parameters may be 0. Also, the processor 201 sets the camera-to-measurement-point-cloud distance calculated at step S3 as the distance r.

At step S5, the processor 201 reads an item of ideal form data 111 corresponding to the measurement target O from, for example, the form DB 11 stored in the storage 204.

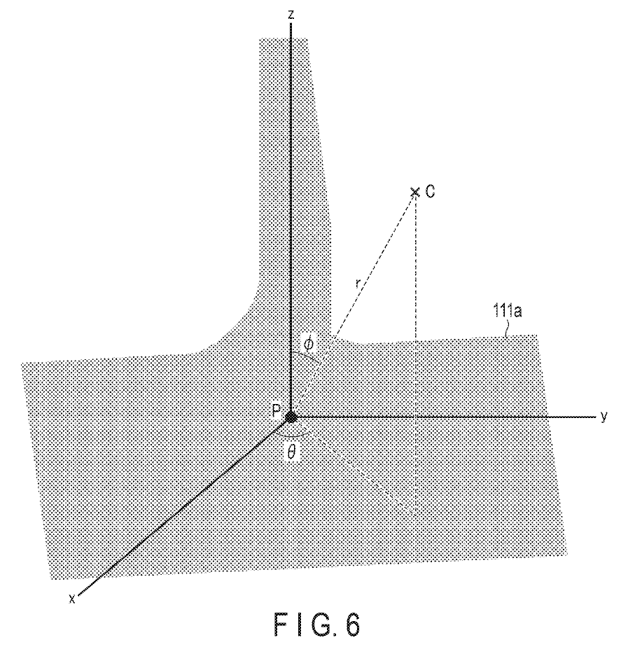

At step S6, the processor 201 generates a simulation point cloud from the ideal form data 111. If the number of the optimization parameters is two, the processor 201 generates, from the ideal form data 111, a point cloud 111a to be acquired with a virtual camera C installed at a position at a distance r from a point of focus P, at a pitch angle θ, and at a yaw angle φ, as shown for example in FIG. 6. Also, if the number of the optimization parameters is four, the processor 201 generates, from the ideal form data 111, a point cloud to be acquired with a virtual camera C installed at a position translated by px and py from the position at the distance r from the point of focus P, at the pitch angle θ, and at the yaw angle φ.

At step S7, the processor 201 compares the simulation point cloud and the measurement point cloud, and determines if a similarity between the simulation point cloud and the measurement point cloud is high. The similarity may be, for example, a score based on a fitness. The fitness is derived based on, for example, a difference between corresponding points at identical coordinates on the simulation point cloud and the measurement point cloud. The maximum value of the fitness is 1. A score s may be calculated from s=(1-f)² where f denotes a fitness. The calculated score shows that, the greater the value, the higher the similarity between the two point clouds. The similarity may be calculated by various techniques other than the score-based technique described above. After the calculation of the similarity, the processor 201 determines, for example, that the similarity is high if the calculated similarity is a highest degree of similarity. Alternatively, the processor 201 determines that the similarity is high if the calculated similarity is equal to or higher than a threshold value. If the similarity is determined at step S7 to be not high, the processing shifts to step S8. If the similarity is determined at step S7 to be high, the processing shifts to step S9.

At step S8, the processor 201 changes values of the optimization parameters. Thereafter, the processing reverts to step S6. In this case, the processor 201 changes the position and posture of the simulation point cloud based on the changed optimization parameters, and performs a comparison with the measurement point cloud based on a similarity. The optimization parameters may be changed by, for example, determining one or more optimization parameters to be changed, changing the values of the optimization parameters determined to be changed, and fixing the values of the remaining optimization parameters.

At step S9, the processor 201 calculates form deviations between the simulation point cloud and the measurement point cloud. The form deviation calculation may be performed by calculating deviations between corresponding points on the simulation point cloud and the measurement point cloud. In the form deviation calculation, the measurement point cloud is a non-downsampled point cloud. The position and posture of the simulation point cloud have been aligned with those of the measurement point cloud, and no further alignment is required.

At step S10, the processor 201 outputs a result of the form deviation calculation. The processor 201 performs, for example, a visualized display on the display apparatus 3, based on the result of the form deviation calculation. For example, the processor 201 overlays a three-dimensional image generated from a simulation point cloud over a three-dimensional image generated from the measurement point cloud, and displays the overlaid images by varying the shading of the display colors according to the magnitude of the form deviations. Thereafter, the processing of FIG. 3 is terminated. In performing the visualized display on the display apparatus 3, the processor 201 may be configured to also display a shooting distance and/or the camera-to- measurement-point-cloud distance on the display apparatus 3. The processor 201 may be further configured, for example, to cause the storage 204 to store the calculation result output as a result of the form deviation calculation, or to transfer the calculation result to an unillustrated server.

As described above, according to the first embodiment, restrictions are impostured, in consideration of the situation where the measurement target O is actually measured with the camera 2, to the optimization parameters used for the optimization process of the position and posture of the simulation point cloud generated from the ideal form data and those of the measurement point cloud. It can thus be expected that the precision reduction in the optimization process is suppressed while reducing the optimization parameters. In the first embodiment, the position and posture of the simulation point cloud, not the measurement point cloud, are changed. Accordingly, a high skill is not required for the measurement of the measurement point cloud.

In addition, in the first embodiment, only a single item of ideal form data suffices for a single measurement target, since the position and posture of the point cloud generated from the ideal form data is aligned with those of the measurement point cloud. It is thereby possible to save the capacity of the form DB 11.

### Second Embodiment

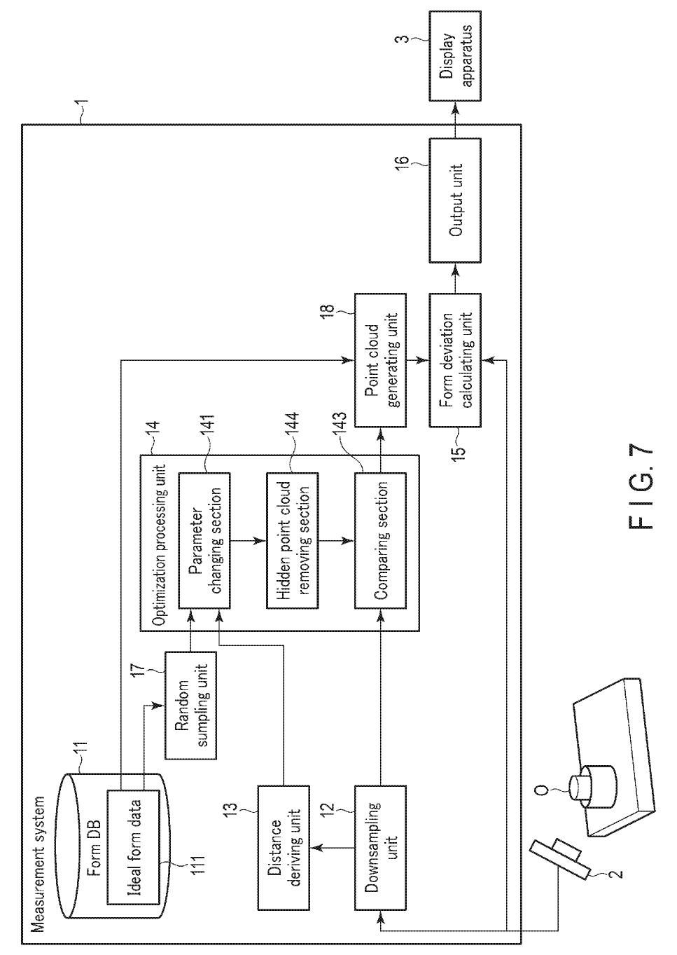

Next, a second embodiment will be described. FIG. 7 is a block diagram showing a configuration of an example of a measurement system according to a second embodiment. In FIG. 7, a description of a configuration similar to that in FIG. 1 will be suitably simplified or omitted.

As shown in FIG. 7, a measurement system 1 according to the second embodiment includes a random sampling unit 17 and a point cloud generating unit 18, in addition to a form database (DB) 11, a downsampling unit 12, a distance deriving unit 13, an optimization processing unit 14, a form deviation calculating unit 15, and an output unit 16. In the second embodiment, the optimization processing unit 14 includes a parameter changing section 141, a hidden point cloud removing section 144, and a comparing section 143. In the second embodiment, similarly to the first embodiment, the processor 201 operates as the downsampling unit 12, the distance deriving unit 13, the optimization processing unit 14, the form deviation calculating unit 15, the output unit 16, the random sampling unit 17, and the point cloud generating unit 18, through execution of, for example, a measurement program stored in a storage 204.

The random sampling unit 17 is adapted to randomly sample a point cloud from an item of ideal form data 111 corresponding to a measurement target O, and inputs the point cloud obtained by the sampling to the parameter changing section 141.

The hidden point cloud removing section 144 is adapted to generate, based on optimization parameters changed by the parameter changing section 141, a point cloud from which a hidden point cloud has been removed, from the point cloud sampled by the random sampling unit 17. The hidden point cloud is a point cloud positioned out of a field of view of the camera 2. The hidden point cloud may be removed by, for example, a known hidden point cloud removing process. The hidden point cloud removing process is a process of removing a point cloud other than a point cloud that falls within a circular cone in a specified direction, which is, in the present embodiment, a shooting direction of the camera 2.

The comparing section 143 is adapted to compare the post-removal point cloud generated by the hidden point cloud removing section 144 and the measurement point cloud downsampled by the downsampling unit 12 based on a similarity. The similarity may be a score calculated in a manner similar to the first embodiment.

The point cloud generating unit 18 generates, based on parameters optimized by the optimization processing unit 14, a simulation point cloud from the ideal form data 111 of the measurement target O. If the number of the optimization parameters is two, the processor 201 generates, from the ideal form data 111, a point cloud to be acquired with a virtual camera C installed at a position at a distance r from a point of focus P, at a pitch angle θ, and at a yaw angle φ. Also, if the number of the optimization parameters is four, the processor 201 generates, from the ideal form data 111, a point cloud to be acquired with a virtual camera C installed at a position translated by px and py from the position at the distance r from the point of focus P, at the pitch angle θ, and at the yaw angle φ.

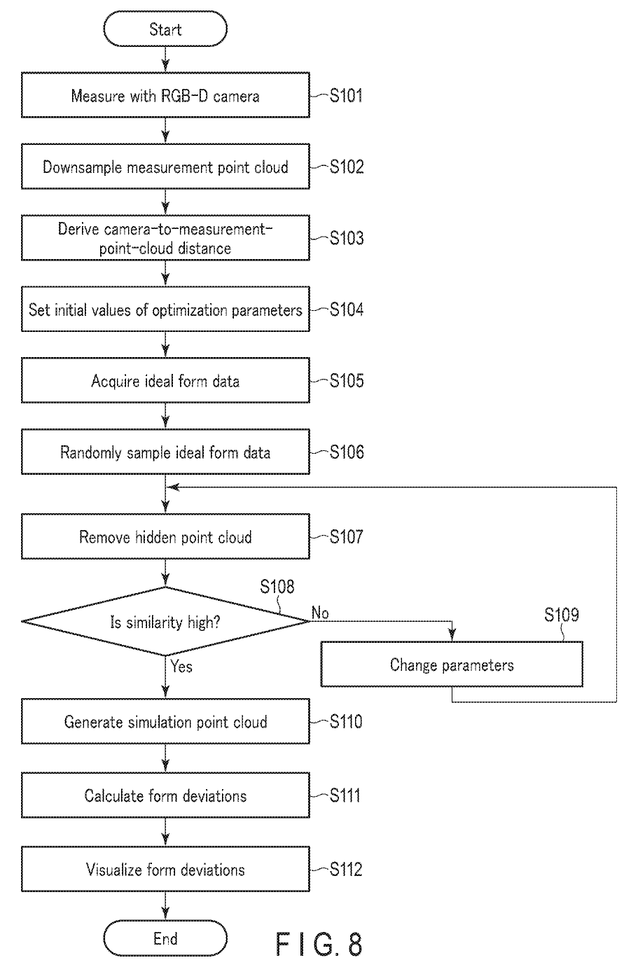

Next, an operation of the measurement system 1 according to the second embodiment will be described. FIG. 8 is a flowchart showing a form deviation visualizing process as an operation of the measurement system 1 according to the second embodiment. The processing of FIG. 8 is executed by the processor 201.

At step S101, the processor 201 controls the camera 2 to carry out measurement of the measurement target O. Thereby, the processor 201 acquires an RGB-D image from the camera 2. Here, the measurement of the measurement target O may be performed under the control of a system different from the measurement system 1. Alternatively, the measurement of the measurement target O may be performed by a user. In this case, the user carries out the measurement of the measurement target O by holding the camera 2 in his or her hand.

At step S102, the processor 201 generates a measurement point cloud from a depth image obtained from the camera 2, and downsamples the measurement point cloud to a density as low as that of a point cloud to be randomly sampled. The downsampling may be performed by a given technique, for example, by averaging adjacent point clouds. Also, the measurement point cloud may be generated by the camera 2.

At step S103, the processor 201 derives, from the measurement point cloud, a camera-to-measurement-point-cloud distance. As described above, the camera-to-measurement-point-cloud distance may be derived as, for example, a distance between a central position of the measurement point cloud, which is derived as an average of Z-direction coordinate values of a point cloud in the neighborhood of the center of a camera plane XY, and a position of a virtual camera that is installed relative to the measurement point cloud.

At step S104, the processor 201 initializes optimization parameters. After determining that the number of the optimization parameters is two or four, the processor 201 initializes each of the optimization parameters. The initial values of the pitch angle θ, the yaw angle φ, the parallel translation amount px, and the parallel translation amount py as the optimization parameters may be 0. Also, the processor 201 sets the camera-to-measurement-point-cloud distance calculated at step S103 as the distance r.

At step S105, the processor 201 reads an item of ideal form data 111 corresponding to the measurement target O from, for example, the form DB 11 stored in the storage 204.

At step S106, the processor 201 randomly samples the point cloud from the ideal form data 111.

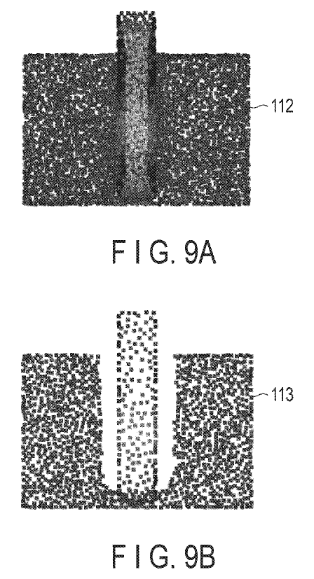

At step S107, the processor 201 removes a hidden point cloud from a randomly sampled point cloud through, for example, a hidden point cloud removing process. With a randomly sampled point cloud 112 shown in FIG. 9A, the point cloud can be seen no matter which direction it is rotated in. On the other hand, since the actual measurement point cloud is configured only of a point cloud that falls within a field of view of the camera 2, there may be a case where the same point cloud as the point cloud 112 cannot be viewed depending on the orientation. That is, the point cloud 112 obtained through simple random sampling may not be enough to be able to mimic the measurement point cloud of the camera 2. Accordingly, a hidden point cloud, positioned out of the field of view of the camera 2, is removed, as shown in FIG. 9B. Through comparison between the measurement point cloud and a post-removal point cloud 113, from which the hidden point cloud has been removed based on a similarity, it is possible to expect improvement in the precision of the optimization process.

At step S108, the processor 201 compares the post-removal point cloud and the measurement point cloud, and determines if a similarity between the post-removal point cloud and the measurement point cloud is high. The similarity may be, for example, a score based on a fitness, similarly to the first embodiment. If the similarity is determined at step S108 to be not high, the processing shifts to step S109. If the similarity is determined at step S108 to be high, the processing shifts to step S110.

At step S109, the processor 201 changes values of the optimization parameters. Thereafter, the processing reverts to step S107. In this case, the processor 201 changes the position and posture of the randomly sampled point cloud based on the changed optimization parameters, and performs a comparison with the measurement point cloud based on a similarity. The optimization parameters may be changed by, for example, determining one or more optimization parameters to be changed, changing the values of the optimization parameters determined to be changed, and fixing the values of the remaining optimization parameters.

At step S110, the processor 201 generates a simulation point cloud from the ideal form data 111 based on the optimized parameters.

At step S111, the processor 201 calculates form deviations between the simulation point cloud and the measurement point cloud. The form deviation calculation may be performed by calculating deviations between corresponding points on the simulation point cloud and the measurement point cloud. In the form deviation calculation, the measurement point cloud is a non-downsampled point cloud. The position and posture of the simulation point cloud have been aligned with those of the measurement point cloud, and no further alignment is required.

At step S112, the processor 201 outputs a result of the form deviation calculation. The processor 201 performs, for example, a visualized display on the display apparatus 3, based on the result of the form deviation calculation. For example, the processor 201 overlays a three-dimensional image generated from simulation point clouds over a three-dimensional image generated from the measurement point clouds, and displays the overlaid images by varying the shading of the display colors according to the magnitude of the form deviations. Thereafter, the processing of FIG. 8 is terminated. In performing the visualized display on the display apparatus 3, the processor 201 may also display a shooting distance and/or the camera-to-measurement-point-cloud distance on the display apparatus 3. The processor 201 may be further configured, for example, to cause the storage 204 to store the calculation result output as a result of the form deviation calculation, or to transfer the calculation result to an unillustrated server.

As described above, according to the second embodiment, restrictions are impostured, in consideration of the situation where the measurement target O is actually measured with the camera 2, to the optimization parameters used for the optimization process of the position and posture of the measurement point cloud and those of the point cloud generated by random sampling from the ideal form data. It can thus be expected that the precision reduction in the optimization process is suppressed while reducing the optimization parameters. In the second embodiment, too, only a single item of ideal form data suffices for a single measurement target, since the position and posture of the point cloud generated from the ideal form data is aligned with those of the measurement point cloud. It is thereby possible to save the capacity of the form DB 11.

Moreover, in the second embodiment, the point cloud used for the optimization process with the measurement point cloud is generated by random sampling from the ideal form data. It is thereby possible to generate a point cloud for the optimization process more easily than the first embodiment. Furthermore, in the second embodiment, a hidden point cloud, which is invisible from the measurement point cloud, is removed from the point cloud generated by random sampling. It can thus be expected that the precision in the optimization process is improved as a result of reduction in the difference between the measurement point cloud and the point cloud conveniently generated by random sampling. In addition, the hidden point cloud removing process can be carried out with a relatively light load. It can thus be expected that the calculation time, etc., is shortened.

The techniques of optimizing the parameters according to the first and second embodiments are based on the so-called Bayesian optimization technique, in which a comparison between a simulation point cloud and a measurement point cloud is performed based on a similarity, while changing values of one or more optimization parameters to be changed. However, the techniques of optimizing the parameters according to the embodiments are not required to be based on the Bayesian optimization technique. Given optimization techniques may be used as the techniques of optimizing the parameters according to the embodiments.

### Third Embodiment

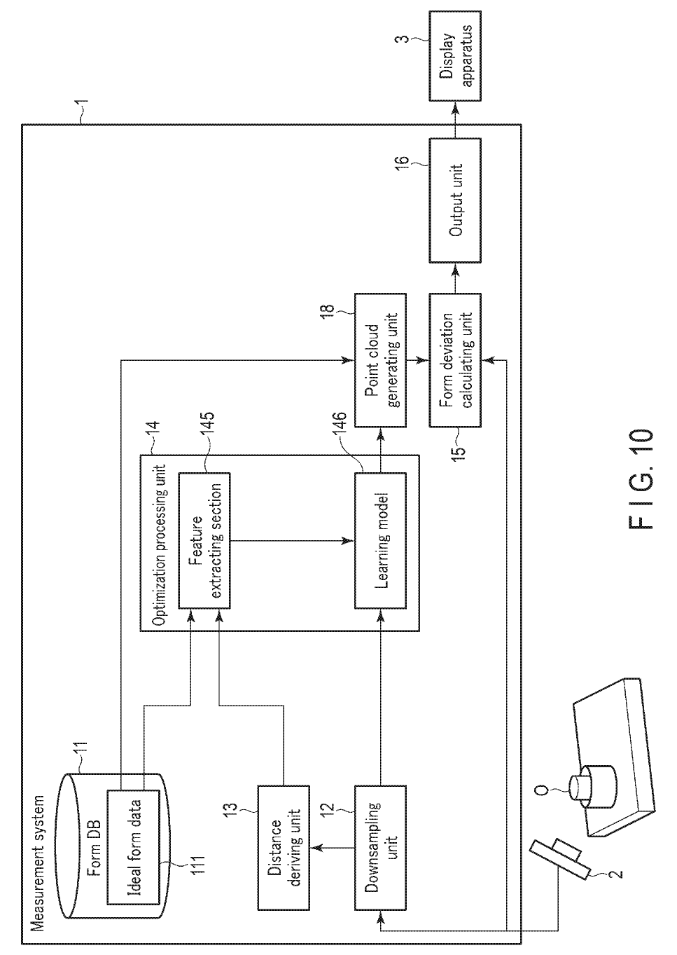

Next, a third embodiment will be described. FIG. 10 is a block diagram showing a configuration of an example of a measurement system according to a third embodiment. In FIG. 10, a description of a configuration similar to that in FIG. 1 or 7 will be suitably simplified or omitted.

As shown in FIG. 10, a measurement system 1 according to the third embodiment includes a point cloud generating unit 18, in addition to a form database (DB) 11, a downsampling unit 12, a distance deriving unit 13, an optimization processing unit 14, a form deviation calculating unit 15, and an output unit 16. Also, in the third embodiment, the optimization processing unit 14 includes a feature extracting section 145 and a learning model 146. In the third embodiment, similarly to the first and second embodiments, the processor 201 operates as the downsampling unit 12, the distance deriving unit 13, the optimization processing unit 14, the form deviation calculating unit 15, the output unit 16, and the point cloud generating unit 18, through execution of, for example, a measurement program stored in a storage 204.

The feature extracting section 145 is adapted to extract, from the ideal form data 111, a feature amount to be input to the learning model 146. The feature amount may contain, for example, a point cloud generated from the ideal form data 111 and a camera-to-measurement-point-cloud distance.

The learning model 146 is a model trained to take, as an input, a feature amount extracted from the ideal form data 111 and a measurement point cloud downsampled by the downsampling unit 12, to solve an optimization problem of optimizing a position and posture of the measurement point cloud against those of the point cloud of the ideal form data 111 using the camera-to-measurement-point-cloud distance as a constrained condition, and to output the optimized position and posture. The learning model 146 may be generated from a point cloud generating model such as PointNet. The training of the learning model 146 may be performed by inputting, to a point cloud processing model, the measurement point cloud and the point cloud generated from the ideal form data 111, and feeding back errors between information on the output position and posture and information on the correct position and posture. The learning model 146 may be, for example, stored in the storage 204. On the other hand, the learning model 146 may be stored in a storage provided on the exterior of the measurement system 1.

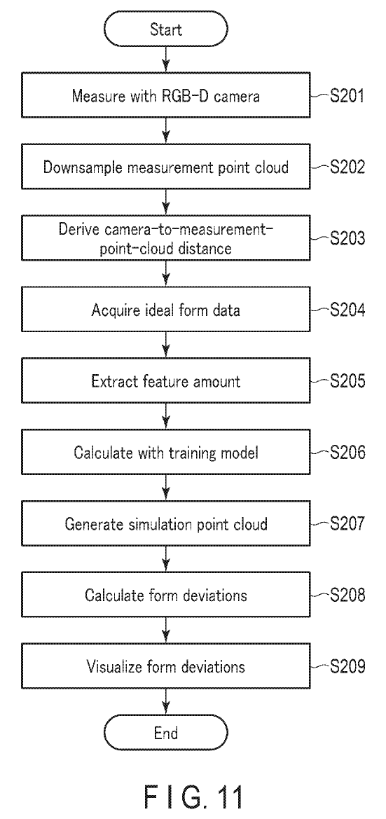

Next, an operation of the measurement system 1 according to the third embodiment will be described. FIG. 11 is a flowchart showing a form deviation visualizing process as the operation of the measurement system 1 according to the third embodiment. The processing of FIG. 11 is executed by the processor 201.

At step S201, the processor 201 controls the camera 2 to carry out measurement of the measurement target O. Thereby, the processor 201 acquires an RGB-D image from the camera 2. Here, the measurement of the measurement target O may be performed under the control of a system different from the measurement system 1. Alternatively, the measurement of the measurement target O may be performed by a user. In this case, the user carries out the measurement of the measurement target O by holding the camera 2 in his or her hand.

At step S202, the processor 201 generates a measurement point cloud from a depth image obtained from the camera 2, and downsamples the measurement point cloud to a density as low as that of a simulation point cloud. The downsampling may be performed by a given technique, for example, by averaging adjacent point clouds. Also, the measurement point cloud may be generated by the camera 2.

At step S203, the processor 201 derives, from the measurement point cloud, a camera-to-measurement-point-cloud distance. As described above, the camera-to-measurement-point-cloud distance may be derived as, for example, a distance between a central position of the measurement point cloud, which is derived as an average of Z-direction coordinate values of a point cloud in the neighborhood of the center of a camera plane XY, and a position of a virtual camera that is installed relative to the measurement point cloud.

At step S204, the processor 201 reads an item of ideal form data 111 corresponding to the measurement target O from, for example, the form DB 11 stored in the storage 204.

At step S205, the processor 201 extracts a feature amount from the ideal form data 111. Here, the form DB 11 may store a feature amount associated in advance with the ideal form data 111. In this case, at step S205, it suffices that the processor 201 acquires a corresponding feature amount of the measurement target O from the form DB 11.

At step S206, the processor 201 inputs, to the learning model 146, the extracted feature amount and the camera-to-measurement-point-cloud distance together with the downsampled measurement point cloud, and calculates a position and posture of a point cloud of the ideal form data 111 at which the similarity to the measurement point cloud is high.

At step S207, the processor 201 generates a simulation point cloud from the ideal form data 111 based on the calculated parameters.

At step S208, the processor 201 calculates form deviations between the simulation point cloud and the measurement point cloud. The form deviation calculation may be performed by calculating deviations between corresponding points on the simulation point cloud and the measurement point cloud. In the form deviation calculation, the measurement point cloud is a non-downsampled point cloud. The position and posture of the simulation point cloud have been aligned with those of the measurement point cloud, and no further alignment is required.

At step S209, the processor 201 outputs a result of the form deviation calculation. The processor 201 performs, for example, a visualized display on the display apparatus 3, based on the result of the form deviation calculation. For example, the processor 201 overlays a three-dimensional image generated from simulation point clouds over a three-dimensional image generated from the measurement point clouds, and displays the overlaid images by varying the shading of the display colors according to the magnitude of the form deviation. Thereafter, the processing of FIG. 11 is terminated. In performing the visualized display on the display apparatus 3, the processor 201 may also display a shooting distance and/or the camera-to-measurement-point-cloud distance on the display apparatus 3. The processor 201 may be further configured, for example, to cause the storage 204 to store the calculation result output as a result of the form deviation calculation, or to transfer the calculation result to an unillustrated server.

As described above, according to the third embodiment, an optimization process of optimizing a position and posture of a measurement point cloud against those of a point cloud of ideal form data is performed using a learning model. By making an input to the machine learning model using a camera-to-measurement-point-cloud distance as a constraint condition, it can be expected to obtain a result with a reduced calculation load.

In the third embodiment, the feature amount may be extracted after a hidden point cloud is removed, similarly to the second embodiment. Through removal of the hidden point cloud, further precision improvement is expected in calculating the position and posture of the point cloud of the ideal form data 111 at which the similarity to the measurement point cloud is high.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A measurement system comprising a processor, the processor including hardware configured to:
calculate, from a measurement point cloud obtained by measuring a measurement target with a camera, a distance obtained by converting a shooting distance from the camera to a point of focus on the measurement target into a value in a space in which the measurement point cloud is arranged;
determine, using the distance as a constraint condition, one or more optimization parameters for an optimization process of aligning a position and a posture of a first point cloud and a position and a posture of the measurement point cloud, the first point cloud being generated from ideal form data representing an ideal form of the measurement target;
performing the optimization process using the determined one or more optimization parameters;
calculating one or more form deviations between a second point cloud and the measurement point cloud, the second point cloud being based on the first point cloud; and
performing a visualized display on a display apparatus based on a result of the calculating of the one or more form deviations.

2. The measurement system according to claim 1, wherein
the first point cloud is a point cloud to be obtained by a virtual camera from which the point of focus on the measurement point cloud is viewed, the virtual camera being assumed to be installed in the space in which the measurement point cloud is arranged, and
the one or more optimization parameters include a pitch angle and a yaw angle in a case where a position of the virtual camera is represented by polar coordinates, with the point of focus being an origin and the distance being fixed.

3. The measurement system according to claim 2, wherein
the one or more optimization parameters further include a translation amount in a direction parallel to a virtual ground surface in the space.

4. The measurement system according to claim 1, wherein
the first point cloud is a point cloud randomly sampled from the ideal form data, and
the processor is configured to perform the optimization process after removing a hidden point cloud from the first point cloud, the hidden point cloud falling out of a field of view of a virtual camera assumed to be installed in the space in which the measurement point cloud is arranged.

5. A computer-readable non-transitory storage medium storing thereon a measurement program for causing a processor to:
calculate, from a measurement point cloud obtained by measuring a measurement target with a camera, a distance obtained by converting a shooting distance from the camera to a point of focus on the measurement target into a value in a space in which the measurement point cloud is arranged;
determine, using the distance as a constraint condition, one or more optimization parameters for an optimization process of aligning a position and a posture of a first point cloud and a position and a posture of the measurement point cloud, and perform the optimization process using the determined one or more optimization parameters, the first point cloud being generated from ideal form data representing an ideal form of the measurement target;
calculate one or more form deviations between the second point cloud and the measurement point cloud, the second point cloud being based on the first point cloud; and
perform a visualized display on a display apparatus based on a result of the calculating of the one or more form deviations.
